(19) United States
(12) Patent Application Publication
(10) Pub. No.: US 2015/0015739 A1
(43) Pub. Date: Jan. 15, 2015

(54) IMAGE CAPTURE DEVICE AND IMAGE CAPTURING METHOD THEREOF

(71) Applicant: ALTEK CORPORATION, Hsinchu City (TW)

(72) Inventors: KEN TENG PENG, Hsinchu City (TW); KUAN WEI PAN, Kaohsiung City (TW); KUO HSUAN FAN, Hsinchu County (TW)

(73) Assignee: ALTEK CORPORATION, Hsinchu City (TW)

(21) Appl. No.: 13/973,184

(22) Filed: Aug. 22, 2013

(30) Foreign Application Priority Data
Jul. 9, 2013 (TW) 102124620

(51) Int. Cl. H04N 5/235

(52) U.S. Cl. CPC H04N 5/2353
USPC 348/231.99

(57) ABSTRACT

The present application discloses an image capture device, including an image capture unit, a processing unit, and a storage unit. The image capture unit captures a plurality of exposure image during exposure duration. The processing unit is electrically connected to the image capture unit, and the processing unit enables the display unit to display the plurality of exposure images captured by the image capture unit during the exposure duration. The storage unit is electrically connected to the processing unit, and the storage unit controls the storage unit to selectively store at least one of the plurality of the exposure images displayed by the display unit.

### CROSS-REFERENCE TO RELATED APPLICATION

This application claims priority from Taiwan Patent Application No. 102124620, filed on Jul. 9, 2013 in Taiwan Intellectual Property Office, the contents of which are hereby incorporated by reference in their entirety.

### BACKGROUND OF THE INVENTION

1. Field of the Invention

The present invention is related to an image capture device and image capturing method thereof, and particularly an image capture device and image capturing method thereof with the capability of previewing and storing exposing images in real time.

2. Description of the Related Art

With the advent of the photographing technology, more and more cameras are not only able to take ordinary snapshots, but also pursue more professional photographing skills. For example, automatic control of shutter's on-off timing enables shooting scenes with different sensations. For example, by using long exposure, some scenes such as starry sky, flowing water, or moving automobiles, light trail variation can be captured. Therefore, long exposure enables camera to capture an object's long-time moving trail.

However, conventional photographing skills of controlling shutter's on-off timing, for example, B shutter or slow shutter, are both unable to display an exposure result of an image during the exposure process when shutter is open. Therefore, a user only can review the exposed image after the exposure process of B shutter or slow shutter. For this reason, a user usually needs to take a plurality of shootings on the same scene or adjust the exposure time for a plurality of times till a desired exposure result is achieved.

### SUMMARY OF THE INVENTION

According to the above problem of the prior arts, the purpose of the present invention is to provide an image capture device and an image capturing method to solve the problem of unable to preview the exposure result of the shooting target during a shutter open period in prior arts.

Based on the purpose of the present invention, an image capture device is disclosed. The image capture device includes an image capture unit, a display unit, a processing unit, and a storage unit. The image capture unit is to capture a plurality of exposure images during the exposure duration. The processing unit is electrically connected to the image capture unit and the display unit, and the processing unit controls the display unit to display a plurality of exposure images during the exposure duration. The storage unit is electrically connected to the processing unit and selectively stored a plurality of exposure images via the control of the processing unit.

Furthermore, the image capture device can further include an exposure duration setting unit to control the time length of the exposure duration.

Furthermore, the image capture device can further include a first trigger switch, a second trigger switch, and a third trigger switch. When the first trigger switch is turned on, the exposure duration begins When the second trigger switch is turned on, the exposure duration ends and the processing unit controls the storage unit to store the exposure images. When the third trigger switch is turned on, the processing unit controls the storage unit to store the exposure images.

Furthermore, the exposure duration includes a first duration, a second duration, and a third duration. The first duration is shorter than the second duration and the second duration is shorter than the third duration.

Furthermore, the first trigger switch and the third trigger switch are in a bootable state and the third trigger switch is in a non-bootable state during the second duration of the exposure duration, and the processing unit will control the display unit to continuously display the plurality of exposure images continuously till the end of the second duration.

Furthermore, in the third duration the first trigger switch and the second trigger switch are in a bootable state and the second trigger switch is in a non-bootable state, and the processing unit controls the display unit to display the plurality of exposure images continuously after the first trigger switch is turned on till the second trigger switch is turned on.

Furthermore, when the image capture unit is storing the plurality of images into the storage unit, the electric charges in the image capture unit can be cleared up or retained.

Furthermore, when the third trigger switch is turned on, the electric charges in the third trigger switch will be retained.

Based on another purpose of the present invention, an image capturing method is proposed, including the following steps: capturing a plurality of exposure images during an exposure duration; displaying the plurality of exposure images during the exposure duration; and selectively storing the plurality of exposure images.

Furthermore, the image capturing method further includes a step of storing at least one of the plurality of exposure images and closing the shutter before the end of the exposure duration.

Furthermore, the image capturing method further includes a step of retaining the electric charges of an image capture unit for capturing the plurality of exposure images during the exposure duration.

Furthermore, the image capturing method further includes a step of storing at least one of the plurality of images during the exposure duration and closing the shutter at the end of the exposure duration.

In summary, the image capture device and the image capturing method of the present invention are able to utilize the processing unit to control the display unit to display the exposure images captured by the image capture unit during the exposure duration. Therefore, the user can preview the exposure images via the display unit and store the exposure images which reaches the expected exposure effect in real time, such that the problem of poor exposure effect caused by the ill setup of the exposure time in conventional skills can be reduced.

### BRIEF DESCRIPTION OF THE DRAWINGS

FIG. 1 is a block diagram of an image capture device according to a first embodiment of the present application.

FIG. 2 is a block diagram of an image capture device according to the second embodiment of the present application.

FIG. 3 is an operation flow chart of an image capture device according to the second embodiment of the present application.

FIG. 4 is the step flow chart of an image capturing method according to an embodiment of the present application.

### DETAILED DESCRIPTION OF THE PREFERRED EMBODIMENTS

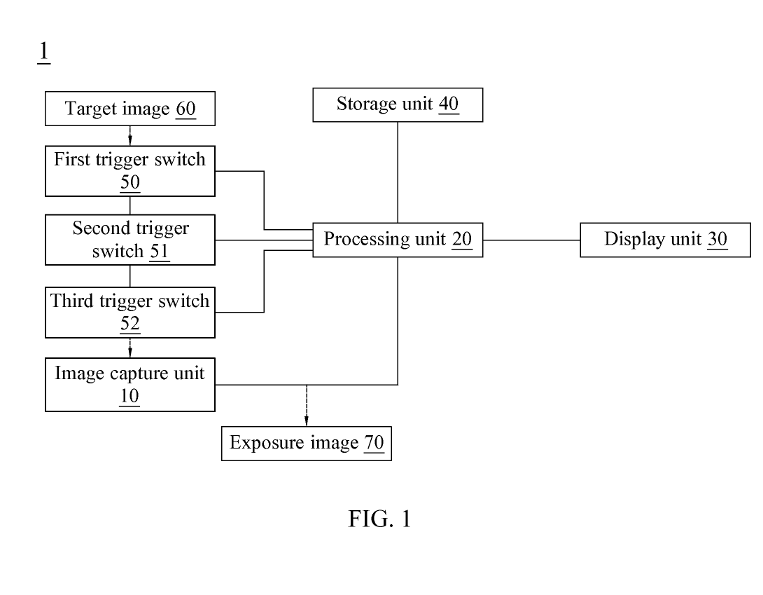

Referring to FIG. 1, FIG. 1 is a block diagram of an image capture device according to a first embodiment of the present application. As shown in FIG. 1, the image capture device 1 includes an image capture unit 10, a processing unit 20, a storage unit 30, and a display unit 40. Wherein, the processing unit 20 is electrically connected to the image capture unit 10, the storage unit 30, and the display unit 40.

The image capture unit 10 can be a light-sensitive coupling device (Charged-Coupled Device, CCD), a complementary metal-oxide semiconductor (CMOS), or other forms of image sensors, for example. The processing unit 20 is electrically connected to the image capture unit 10 to transfer a plurality of exposure images captured by image capture unit 10 to the storage unit 30, or control the display unit 40 to display the plurality of exposure images captured by the image capture unit 10.

It is noteworthy to mention that according to this embodiment, when the plurality of exposure images captured by the image capture unit 10 are processed by the processing unit 20, the processing unit 20 can remove or retain the exposure image information in the image capture unit 10 in every output transaction. More detail, the processing unit 20 can remove or retain electric charges stored in the image capture unit 10 (such as a CCD or a CMOS) after outputting of the exposure image information.

In this way, by controlling the electric charges to be stored in the image capture unit 10 after outputting the image information, the processing units 20 can control the display units 40 to continuously display real-time exposure images captured by the image capture unit 10 in a period of time. For example, assume the image capture device 10 of the present embodiment is a digital camera. When a user performs long exposure photography on a target image 60, the image capture unit 10 may continuously capture exposure images 70 during an exposure duration of the digital camera. If the electric charges in the image capture unit 10 are not removed after outputting the exposure image information, the processing units 20 can control the display unit 40 to display the plurality of exposure images 70 captured by the image capture unit 10 during the exposure duration. Under this condition, if the exposure duration is ten seconds, for example, an exposure image the user reviews on the display unit 40 at a timing of the fifth second is the image information accumulated from zero to five seconds. However, the present application is not limited to the above embodiment, and the exposure duration can be one to thirty seconds, for example.

In the present embodiment, the user can pick up a desired exposure image by previewing real-time exposure images 70 captured by the image capture unit 10 during the exposure duration, and then the processing units 20 will control the storage unit 30 to store the desired exposure image displayed on the display unit 40.

More detail, the image capture device 1 further includes a first trigger switch 50, a second trigger switch 51, and a third trigger switch 52. The first trigger switch 50, the second trigger switch 51, and the third trigger switch 52 can be positioned between the target image 60 and the image capture unit 10 and are electrically connected to the processing unit 20 respectively, so as to control light beam on the target image 60 side to be or not to be transmitted to the image capture unit 10. Wherein, when the first trigger switch 50 is turned on, the exposure duration begins On the other hand, when the second trigger switch 51 is turned on, the exposure duration ends and the processing unit 20 can control the storage units 30 to store the exposure image 70 of the exposure duration.

Besides, if the third trigger switch 52 is turned on during the above exposure duration, the processing units 20 can control the storage unit 30 to store an exposure image 70 of an exposure duration between the first trigger switch's 50 being turned on and the third trigger switch's 52 being turned on. It is noteworthy to mention that no matter the exposure duration is terminated by turning off the second trigger switch 51 or being terminated automatically, in both situations the processing units 20 can control the storage unit 30 to store the exposure image 70 of the exposure duration when the exposure duration is terminated.

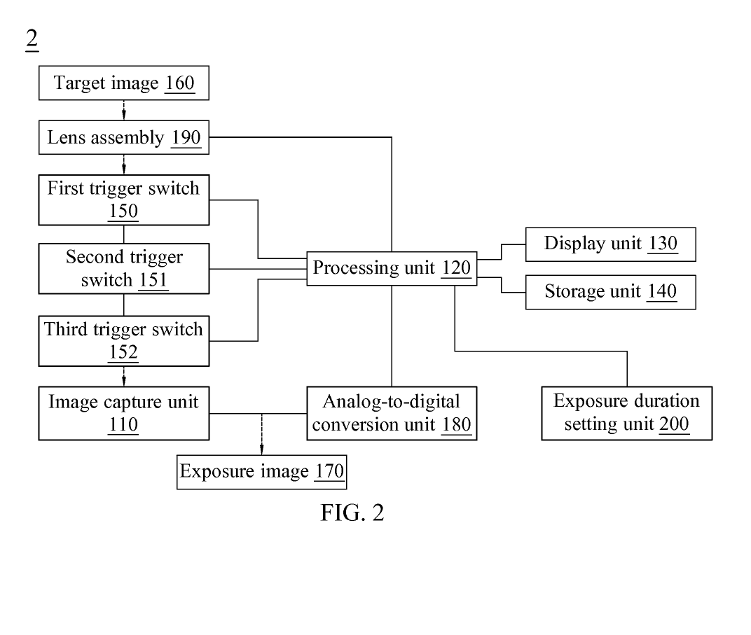

Referring to FIG. 1 and FIG. 2, FIG. 2 is a block diagram of an image capture device according to a second embodiment of the present application. As shown in FIG. 2, each unit of the image capture device in FIG. 2 is similar to that of the image capture device of the first embodiment. Therefore, the detail description of each unit will not be repeated here. However, it is noteworthy to mention that in the present embodiment the image capture device 2 can include an image capture unit 110, an processing unit 120, a display unit 130, a storage unit 140, and a first trigger switch 150, a second trigger switch 151, a third trigger switch 152, an analog-to-digital conversion unit 180, a lens assembly 190, and an exposure duration setting unit 200. Furthermore, the analog-to-digital conversion unit 180 is electrically connected between the image capture unit 110 and the processing unit 120. Besides, the processing unit 120 is further electrically connected to the storage unit 130, the display unit 140, the lens assembly 190, the first trigger switch 150, the second trigger switch 151, the third trigger switch 152, and the exposure duration setting unit 200. Wherein, the lens assembly 100 can be controlled by the processing unit 120 to focus on a desired shooting image automatically.

The image capture device 2 in the present embodiment can be a digital camera or a portable electronic apparatus, but it is not limited thereto. The image capture unit 110 can be a Charged-Coupled Device (CCD), a complementary metal-oxide semiconductor (CMOS), or other forms of image sensors, for example.

The analog-to-digital conversion unit 180 is electrically connected to the image capture unit 110 to convert the image signal captured by the image capture unit 110 into a digital signal. It is noteworthy to mention that the image capture unit 110 can be set up to clear up the exposure image information at every output of the exposure image information or to retain the exposure image information at every output of the exposure image information.

The exposure duration setting unit 200 of the present application is used to set up the time length of the exposure duration. Wherein, the exposure duration includes a first duration, a second duration, and a third duration. The first duration is shorter than the second duration and the second duration is shorter than the third duration.

Furthermore, the first trigger switch 150 and the third trigger switch 151 are in a bootable state and the second trigger switch 152 is in a non-bootable state during the second duration, and the processing unit 120 will control the display unit 140 to continuously display the plurality of exposure images 170 till the second duration is ended.

Moreover, the first trigger switch 150 and the second trigger switch 151 are in a bootable state and the third trigger switch 152 is in a non-bootable state during the third duration, and the processing unit 120 will control the display unit 140 to continuously display the plurality of exposure images 170 from the first trigger switch's 50 being turned on till the second trigger switch's 51 being turned on.

More detail, the image capture unit 110 (such as a CCD or a CMOS) can be set up to clear up electric charges in the CCD or CMOS at every output of the exposure image information or to retain electric charges in the CCD or CMOS at every output of the exposure image information.

In this way, the processing units 120 may control the display units 140 to continuously display in real time all the exposure images captured by the image capture unit 110 in a period of time by using the processing unit 120 to set up the image capture unit 110 to retain the electric charges after the output of the image information. For example, assume the image capture device 2 of the present embodiment is a digital camera. When a user is performing a long exposure on a target image 160, the image capture unit 110 may continuously capture the exposure image 170 during the exposure duration. If the electric charges in the image capture unit 110 are not cleared up after outputting the exposure image information, the processing units 120 can control the display unit 140 to display the plurality of exposure images 170 captured by the image capture unit 110 during the exposure duration. Under this situation, if the exposure duration is ten seconds, for example, an exposure image previewed by the user on the display unit 140 at the fifth second is the image information accumulated from zero to five seconds.

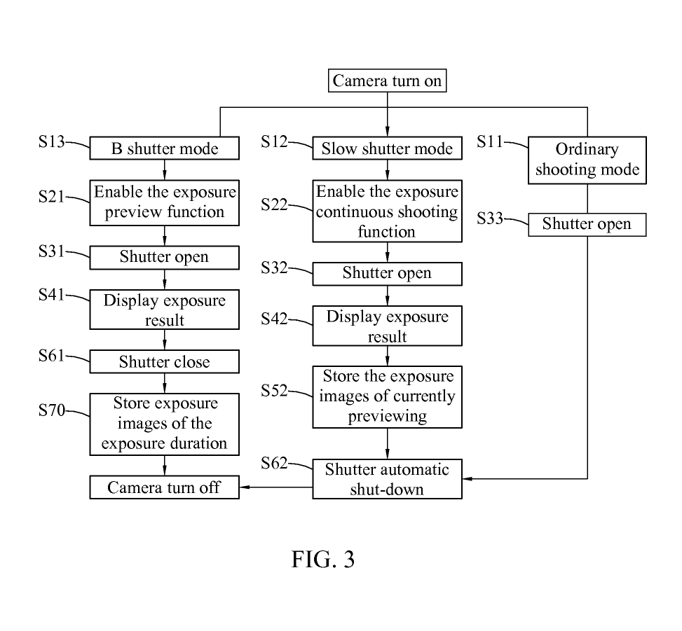

Next, please refer to FIG. 2 and FIG. 3. FIG. 3 is a flow chart of an operation procedure of the image capture device according to the second embodiment of the present application. As shown in the figures, when a user uses the image capture device 2 of the present embodiment to capture a target image 160, he or she can use the exposure duration setting unit 200 to set up the length of the exposure duration (such as the first duration, the second duration, or the third duration) in advance and then performs the target image's 160 capturing process. In the present embodiment, the first duration can be an ordinary shooting mode S11, the second duration can be slow shutter mode S12, and the third duration can be B shutter mode S13. Wherein, B shutter mode S13 means the camera's exposure time can be manually setup, and slow shutter mode S12 means the exposure time is set up as a predetermined time. For example, the exposure time can be set up as thirty seconds and the shutter will be closed automatically after thirty seconds. Besides, the predetermined time can be one to thirty seconds, for example. Further, each trigger state (such as turning on of the first trigger switch 50, the second trigger switch 51, or the third trigger switch 52) during different exposure duration (such as the first duration, the second duration, or the third duration) will have different function. Therefore, under different exposure duration, a shutter button can be used to switch between the first trigger switch 50, the second trigger switch 51, or the third trigger switch 52.

First, an example is taken by performing B shutter mode S13 on the target image 160. In the present embodiment, the exposure duration is initiated by turning on the first trigger switch 51. During the exposure duration, the processing unit 120 controls the display unit 140 to display the exposure images 170 corresponding to the target image 160 so as to make the user to preview the exposure images captured by the image capture unit 110 during the exposure duration on the display unit 140.

In practical applications, the user may further choose to turn on an exposure preview function S21 after choosing B shutter mode S13. Under turning on the exposure preview function S21, the exposure duration S31 begins when the first trigger switch 51 is turning on by pressing the shutter button. At this moment, the processing unit 120 can control the display unit 140 to display the exposure result S41 of the target image 160 which is being captured. When the exposure result of the target image 160 reaches user's expectation, he or she may press the shutter button again to turn on the second trigger switch 51, i.e., to end the exposure duration S61 and go to step S71: store the exposure images 170 of the exposure duration into the storage unit 130.

Besides, if the user decides to use slow shutter mode S12, he or she may further select to turn on the exposure preview function S21 or turn on an exposure continuous shooting function S22. If the user decides to turn on the exposure preview function S21, an operation flow of S21 to S51 is proceeded. If the user decides to turn on the exposure continuous shooting function S22, then the exposure duration 32 is initiated when the first trigger switch 50 is turned on by pressing the shutter button. At this moment, the processing unit 120 can control the display unit 140 to display the exposure result S42 of the target image under shooting. Besides, every time when the third trigger switch 52 is turned on by pressing the shutter button, the step S52 is proceeded and the exposure image 170 under previewing is stored into the storage unit 130. It is noteworthy to notice that under slow shutter mode S 12, the second trigger switch 51 cannot be triggered to close the shutter by pressing the shutter button. The display unit 140 will continuously display the exposure result of the target image 160 under shooting till a preset period time is expired. Then, the shutter will be automatically closed (step S62) and a step S71 is proceeded: store the exposure images 170 of the exposure duration into the storage unit 130.

It is noteworthy to mention that when the user is previewing the exposure result of the desired shooting image, he or she may choose to display current exposure result on the display unit in every one second or every 0.5 seconds. In this way, the exposure images 170 displayed on the display unit 140 can have a higher resolution.

Except B shutter mode S13 and slow shutter mode S12, the present embodiment can also perform an ordinary shooting mode S11, i.e., initiating the exposure duration S33 by pressing the shutter button and turning on the first trigger switch 50, and then automatically closing the shutter and proceeding step S71: store the current exposure image 170 under previewing into the storage unit 130.

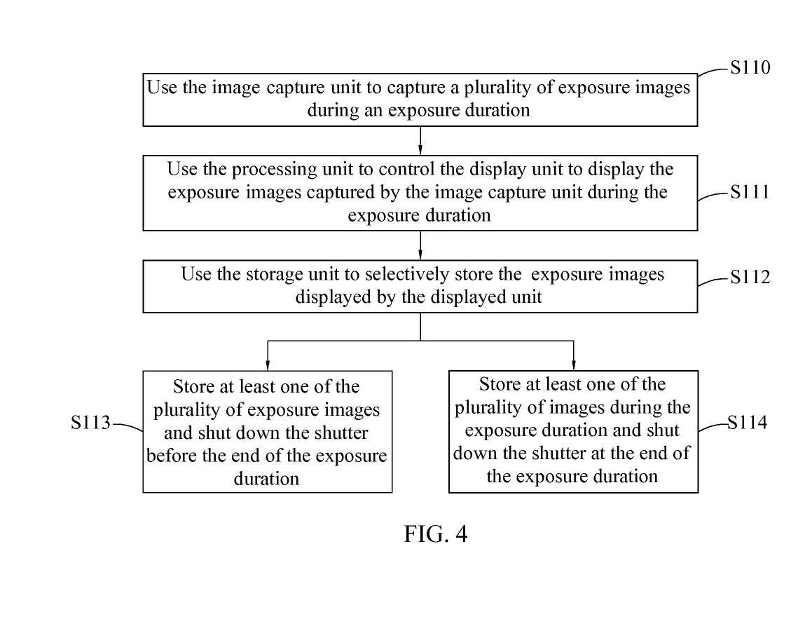

Referring to FIG. 4, FIG. 4 is a flow chart of an image capturing method according to an embodiment of the present application. Please also refer to FIG. 1 to FIG. 3. As shown in FIG. 4, first, in step S110, the image capture unit is used to capture a plurality of exposure images during the exposure duration. Next, in step S111, the processing unit is used to control the display unit to display the exposed images captured by the image capture unit during the exposure duration. In step S112, the storage unit is used to selectively store the exposed images display by the display unit. In this way, the user may review the real time exposure result of the desired shooting image by using the image capturing method of the present application, and choose the desired exposure images to be stored into the storage unit.

Moreover, the image capturing method of the present application may further include a step S113 for storing at least one of the plurality of exposure images and closing the shutter before the end of the exposure duration. That is, when the image capture device of the present application is in B shutter mode S13, the processing unit 120 can control the display unit 140 to display the exposure result of the target image 160 under shooting. When the exposure result of the target image 160 reaches user's expectation, the user can press the shutter button again to turn on the second trigger switch 51 to end the exposure duration S61, to store the exposure images 170 of the exposure duration into the storage unit 130, and close the shutter.

Furthermore, in step S113, the processing unit 20 can be used to control the image capture unit 10 (such as a CCD or a CMOS) not to clean up electric charges stored therein after the exposure image information is being output.

Besides, the image capturing method of the present application may further include a step S114 for storing at least one of the plurality of images during the exposure duration and closing the shutter at the end of the exposure duration. That is, when the image capture device of the present application is in slow shutter mode S12, the processing unit 120 can control the display unit 140 to display the exposure result of the target image 160 under shooting. Meanwhile, each exposure image 170 under preview can be stored into the storage unit 130 every time when the shutter button is pressed and the third trigger switch 52 is turned on, and the display unit 140 will also continuously display the exposure result of the target image 160 under shooting till a preset period time is expired. Then, the shutter is automatically closed and the exposure image 170 of the exposure duration is stored into the storage unit 130.

In this way, the user can preview the exposure result of the desired shooting image in real time by using the image capturing method of the present application. When the user sees a favorite exposure result, he or she may press the shutter button to store it in real time.

In summary, according to the image capture device and image capturing method of the present application, the processing unit can be used to control the display unit to display the real-time exposure result of the desired shooting image so as let the user to preview the exposure image in advance and then decide whether to take and store to the storage unit or not. Thus, by using the image capture device and image capturing method of the present application, when a user wants to take a scene which requires a long exposure, such as star trails or waterfalls, the user can choose to store the exposure image at any exposure time. In this way, poor exposure situation caused by error setting of the exposure time can be eliminated.

The aforementioned preferred embodiment is to explain the technical ideas and features of the present application. The purpose is to enable those who skilled in this technical area to understand the content of the present application and realize it. It will be understood that the present application is not limited to the details thereof. Various equivalent variations and modifications may still occur to those skilled in this art in view of the teachings of the present application. Thus, all such variations and equivalent modifications are also embraced with the scope of the present application as defined in the appended claim.

What is claimed is:

1. An image capture device, comprising:
an image capture unit, adapted to capture a plurality of exposure images during an exposure duration;
a display unit;
a processing unit, adapted to electrically connected to the image capture unit and the display unit, wherein the processing unit enables the display unit to display the plurality of exposure images during the exposure duration; and
a storage unit, adapted to electrically connected to the processing unit and to selectively store at least one of the plurality of exposure images via the control of the processing unit.

2. The image capture device of claim 1, further comprising an exposure duration setting unit to control the time length of the exposure duration.

3. The image capture device of claim 2, further comprising a first trigger switch, a second trigger switch, and a third trigger switch, wherein the exposure duration begins when the first trigger switch is turned on, the exposure duration ends and the processing unit control the storage unit to store an exposure image when the second trigger switch is turned on, and the processing unit control the storage unit to store an exposure image when the third trigger switch is turned on.

4. The image capture device of claim 3, wherein the time length of the exposure duration comprises a first duration, a second duration, and a third duration, wherein the first duration is shorter than the second duration and the second duration is shorter than the third duration.

5. The image capture device of claim 4, wherein in the second duration, the first trigger switch and the third trigger switch are in a bootable state and the third trigger switch is in a non-bootable state, and the processing unit controls the display unit to display the plurality of exposure images continuously till the end of the second duration.

6. The image capture device of claim 4, wherein in the third duration, the first trigger switch and the second trigger switch are in the bootable state and the third trigger switch is in the non-bootable state, and the processing unit controls the display unit to display the plurality of exposure images continuously when the first trigger switch is turned on and stop displaying the plurality of exposure images when the second trigger switch is turned on .

7. The image capture device of claim 4, wherein when the plurality of images is stored into the storage unit, electric charges included in the image capture unit are removed or retained.

8. The image capture device of claim 7, wherein when the third trigger switch is turned on, the electric charges of the image capture unit are retained.

9. An image capturing method, comprising the following steps of:
capturing a plurality of exposure images during an exposure duration;
displaying the plurality of exposure images during the exposure duration; and
selectively storing the plurality of exposure images.

10. The image capturing method of claim 9, further comprising a step of storing at least one of the plurality of exposure images before the end of the exposure duration and closing shutter.

11. The image capturing method of claim 10, further comprising a step of retaining electric charges of an image capture unit for capturing the plurality of exposure images during the exposure duration.

12. The image capturing method of claim 9, further comprising a step of storing at least one of the plurality of images during the exposure duration and closing shutter at the end of the exposure duration.
